(19) United States
(12) Patent Application Publication
(10) Pub. No.: US 2023/0040523 A1
(43) Pub. Date: Feb. 9, 2023

(54) METHOD FOR THE PRODUCTION OF A POLYESTER CARBONATE

(71) Applicant: COVESTRO INTELLECTUAL PROPERTY GMBH & CO. KG, Leverkusen (DE)

(72) Inventors: Jan HEIJL, Lokeren (BE); Annabelle BERTIN, Antwerpen (BE); Alexander MEYER, Düsseldorf (DE); Helmut Siegen HEUER, Siegen (DE)

(21) Appl. No.: 17/783,790

(22) PCT Filed: Dec. 15, 2020
(86) PCT No.: PCT/EP2020/086088

§ 371 Date: Jun. 9, 2022

(30) Foreign Application Priority Data
Dec. 16, 2019 (EP) 19216474.7

(51) Int. Cl. C08G 63/64; C08G 63/83; C08G 63/87

(52) U.S. Cl. CPC C08G 63/64; C08G 63/83; C08G 63/87

(57) ABSTRACT

The present invention relates to a method for producing an aliphatic polyester carbonate, the polyester carbonate itself, and to moulding compositions and moulded articles containing the polyester carbonate. The claimed method is characterised in particular in that the method comprises three steps and the last step is a melt transesterification method in the presence of two catalysts.

The present invention relates to a process for producing a polyester carbonate, to the polyester carbonate itself produced by the process, to a molding compound comprising the polyester carbonate, and to moldings comprising the polyester carbonate.

Polyesters, polycarbonates and polyester carbonates are known to have good mechanical properties and good stability to heat distortion and to weathering. Depending on the monomers used, each polymer group has certain key features that characterize materials of this type. For instance, polycarbonates have in particular good mechanical properties, whereas polyesters often exhibit better chemical stability. Depending on the chosen monomers, polyester carbonates combine property profiles from both of said groups.

Although aromatic polycarbonates or polyesters often do have a good property profile, they exhibit shortcomings in their stability to ageing and to weathering. For example, absorption of UV light leads to yellowing and sometimes embrittlement of these thermoplastic materials. Aliphatic polycarbonates and polyester carbonates have better properties in this respect, in particular better stability to ageing and/or to weathering and better optical properties, for example transmission.

The drawback with aliphatic polycarbonates or polyester carbonates is often the low glass transition temperature thereof. It is accordingly advantageous to use cycloaliphatic alcohols as (co)monomers. Examples of such cycloaliphatic alcohols are TCD alcohol (tricyclodecanedimethanol), cyclohexanediol, cyclohexanedimethanol, and biobased diols based on 1,4:3,6-dianhydrohexitols such as isosorbide and the isomers isomannide and isoidide. To increase the glass transition temperature further, cycloaliphatic acids such as cyclohexane-1,2-, -1,3- or -1,4-dicarboxylic acids can also be used as (co)monomers. Depending on the choice of reactants, polyesters or polyester carbonates are then obtained. The polyesters of cyclohexanedicarboxylic acid and isosorbide are described by Oh et al. in Macromolecules 2013, 46, 2930-2940, whereas the present invention is directed to polyester carbonates.

Polyester carbonates are produced on an industrial scale for example by transesterification of corresponding ester-containing monomers with diols. For instance, the polyester of cyclohexane-1,4-dimethanol and cyclohexane-1,4-dicarboxylic acid is produced starting from the dimethyl ester of the diacid (blend of this polyester and polycarbonate: Xyrex® from DuPont).

For the transesterification reaction, phenyl esters are however significantly more reactive than their aliphatic analogs. EP 3026074 A1 and EP 3248999 A1 describe processes for producing polyester carbonates having phenyl esters as an intermediate step.

Example 1 of EP 3026074 A1 describes the direct reaction of the diacid with phenol to form the corresponding ester. In example 2 of EP 3026074 A1, a dimethyl ester is reacted with phenol. The yield for both phenyl ester production variants is however capable of being improved further. This is then followed by production of the polyester carbonate.

EP 3248999 A1 describes the production of a diphenyl ester in a solvent and with the use of phosgene. Given that the subsequent reaction to form the aliphatic polyester carbonate does not involve the use of phosgene, the combination of a phosgene process with a transesterification process in the same part of a plant is very disadvantageous. The process described in EP 3248999 A1 is accordingly suboptimal too.

In Kricheldorf et al. (Macromol. Chem. Phys 2010, 211, 1206-1214) it is reported that a polyester based on cyclohexanedicarboxylic acid and isosorbide is not obtainable from cyclohexanedioic acid or from the cyclohexane dimethyl ester (or gives only very low molecular weights) and can be produced only from the acid chloride of cyclohexanedicarboxylic acid.

WO2002/10111 A1 describes a process for producing a polyester carbonate in which an aliphatic linear diacid is first reacted with diphenyl carbonate to form the diphenyl ester. In this document there are no examples demonstrating that the process can also be executed with the cycloaliphatic diacids, which are usually less thermally stable. This document also describes the use of very small amounts of alkali metal ions as catalyst in the examples and a very wide range of amounts in the general part. In addition, a quaternary nitrogen base is used as a further catalyst. These are generally salts of low volatility that normally remain in the reaction system. The diesters obtained are then additionally reacted with aromatic alcohols (such as phenol) to form a polyester carbonate. Phenols have significantly higher acidity than aliphatic alcohols.

The production of aliphatic, in particular cycloaliphatic, polyester carbonates thus continues to pose problems for those skilled in the art. The reactivity of the starting materials and of the intermediate products can be boosted only to a limited degree by higher temperatures, otherwise degradation of the polyester carbonate occurs. An excessive increase in reaction times can, in addition to the immediate practical drawbacks, also result in degradation.

It was accordingly an object of the present invention to provide a process for producing a polyester carbonate in which at least one disadvantage of the prior art is improved. A particular object of the present invention was to provide a process that achieves adequate polymer growth without severe degradation of the polymer.

Adequate polymer growth is in the context of the present invention understood as meaning that the relative viscosity of the polyester carbonate is within a range from 1.18 to 1.30. If the relative viscosity is above this range, thermoplastic processability is possible only with difficulty. A relative viscosity that is too low results in inadequate mechanical and thermal properties.

Unless otherwise stated, the relative viscosity of the polyester carbonate is determined via measurement using an Ubbelohde viscometer and methylene chloride as solvent at 25° C. A solution containing 1 percent by weight of polyester carbonate is used. Those skilled in the art are familiar with the determination of relative solution viscosity using an Ubbelohde viscometer. This is in accordance with the invention preferably carried out as per DIN 51562-3; 1985-05. In this determination, the transit times of the polyester carbonate under investigation are measured by the Ubbelohde viscometer in order to then determine the difference in viscosity between the polymer solution and its solvent. For this, the Ubbelohde viscometer undergoes an initial calibration through measurement of the pure solvents dichloromethane, trichloroethylene, and tetrachloroethylene (always performing at least 3 measurements, but not more than 9 measurements). This is followed by the calibration proper with the solvent dichloromethane. The polymer sample is then weighed out, dissolved in dichloromethane and the flow time for this solution then determined in triplicate. The average of the flow times is corrected via the Hagenbach correction and the relative solution viscosity calculated.

A polyester carbonate that is not severely degraded is light-colored, transparent, and not brittle.

It has surprisingly been found that the desired improvements are shown by the process for producing a polyester carbonate comprising the steps of:
(i) reacting a mixture comprising at least one linear aliphatic dicarboxylic acid and/or at least one cycloaliphatic dicarboxylic acid and at least one aliphatic and/or aromatic carbonate, in the presence of at least one first catalyst that is basic, to form an aliphatic diester of formula (1)

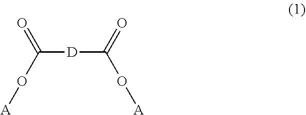

in which
A in each case independently represents an aliphatic or aromatic radical,
   D represents R₃ or one of formulas (1a) or (1b),
where R₃ represents a linear alkylene group having 3 to 16 carbon atoms and this alkylene group may optionally be mono- or polysubstituted or

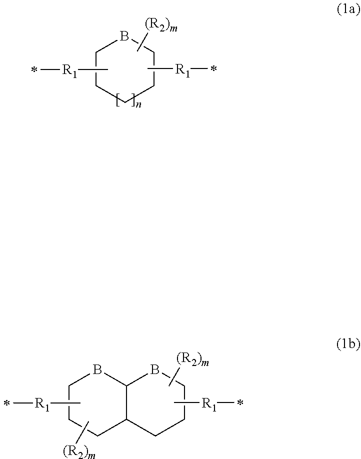

in which
B in each case independently represents a CH₂ group, O or S,
R₁ in each case independently represents a single bond or an alkylene group having 1 to 10 carbon atoms and
R₂ in each case independently represents an alkyl group having 1 to 10 carbon atoms,
n is a number between 0 and 3,
m is a number between 0 and 6 and “*” indicate the positions at which the
—(C═O)OA groups in formula (1) are present,
(ii) separating the aliphatic diester of formula (1) from the mixture from process step (i), (iii) reacting the separated aliphatic diester of formula (1), at least one dihydroxy compound, and at least one diaryl carbonate in a melt transesterification process in the presence of a mixture comprising a second catalyst and a third catalyst,
wherein the second catalyst is a tertiary nitrogen base,
wherein the third catalyst is a basic alkali metal salt,
and wherein the proportion of alkali metal cations in process step (iii) is 0.0010% to 0.0030% by weight based on all components used in process step (iii).

It has also been found that the desired improvements are shown by a process for producing a polyester carbonate comprising the steps of:
(i) reacting a mixture comprising at least one cycloaliphatic dicarboxylic acid and at least one aliphatic and/or aromatic carbonate, in the presence of at least one first catalyst that is basic, to form a cycloaliphatic diester of formula (Ia) or (Ib)

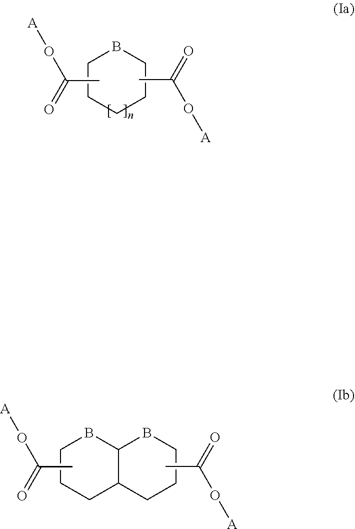

in which
A in each case independently represents an aliphatic or aromatic radical,
B in each case independently represents a carbon atom or a heteroatom selected from the group consisting of O, S, and N, and
n is a number between 0 and 3,
(ii) separating the cycloaliphatic diester of formula (Ia) or (Ib) from the mixture from process step (a),
(iii) reacting the separated cycloaliphatic diester of formula (Ia) or (Ib), at least one dihydroxy compound, and at least one diaryl carbonate in a melt transesterification process in the presence of a mixture comprising a second catalyst and a third catalyst,
wherein the second catalyst is a tertiary nitrogen base,
wherein the third catalyst is a basic alkali metal salt,
and wherein the proportion of alkali metal cations in process step (iii) is 0.0010% to 0.003% by weight based on all components used in process step (iii).

It is according to the invention preferable that in formula (1), (1a) or (1b) both A are identical. It is additionally preferable for them to represent a substituted or unsubstituted phenyl group, particularly preferably an unsubstituted phenyl group. It is according to the invention preferable that in formula (Ia) or (Ib) both A are identical. It is additionally preferable for them to represent a substituted or unsubstituted phenyl group, particularly preferably an unsubstituted phenyl group.

It is also preferable that in formula (1a) n is 0 or 1. It is also preferable that in formula (Ia) n is 0 or 1.

At least one, preferably all, of the abovementioned objects were achieved by the present invention.

In process step (i), at least one linear aliphatic dicarboxylic acid and/or at least one cycloaliphatic dicarboxylic acid is according to the invention used. It is preferable that at least one cycloaliphatic dicarboxylic acid is used. It is also preferable that at least one linear aliphatic dicarboxylic acid is used. It is also preferable that a mixture of a linear aliphatic dicarboxylic acid and a cycloaliphatic dicarboxylic acid is used.

It is particularly preferable that the aliphatic diester of the invention is represented by the general formula (1):

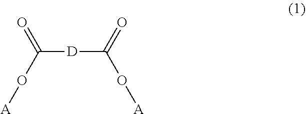

in which
A in each case independently represents an aliphatic or aromatic radical,
   D represents R₃ or one of formulas (1a) or (1 b),
where R₃ represents a linear alkylene group having 3 to 16 carbon atoms, preferably 3 to 8 carbon atoms, more preferably 3 to 6 carbon atoms, further preferably 3 or 4 carbon atoms, and this alkylene group may optionally be mono- or polysubstituted or

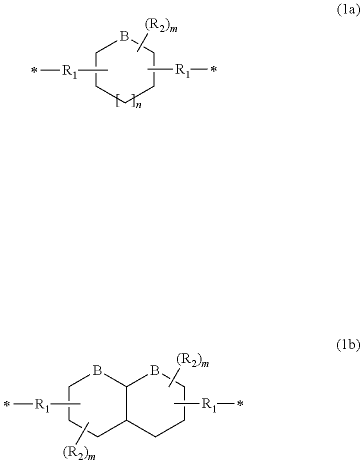

in which
B in each case independently represents a CH₂ group, O or S,
R₁ in each case independently represents a single bond or an alkylene group having 1 to 10 carbon atoms, preferably a single bond or an alkylene group having 1 to 9 carbon atoms, more preferably a single bond or an alkylene group having 1 to 8 carbon atoms, likewise preferably a single bond or an alkylene group having 1 to 5 carbon atoms, particularly preferably a single bond, and
R₂ in each case independently represents an alkyl group having 1 to 10 carbon atoms, preferably 1 to 9 carbon atoms, more preferably 1 to 8 carbon atoms,
n is a number between 0 and 3, preferably between 0 and 2, particularly preferably between 0 and 1, very particularly preferably 1,
m is a number between 0 and 6, preferably between 0 and 3, particularly preferably between 0 and 2, very particularly preferably 0, and “*” indicate the positions at which the —(C═O)OA groups in formula (1) are present.

When R₁ represents a single bond, it will be appreciated that R₁ accordingly comprises zero carbon atoms.

The term “linear alkylene group” and “linear (aliphatic) dicarboxylic acid” is in accordance with the invention used to differentiate from a “cycloaliphatic alkylene group” and “cycloaliphatic dicarboxylic acid” respectively. The linear variant does not contain any ring system. It is however possible for R₃ by way of example, which represents a linear alkylene group, to be optionally substituted. As a consequence, the linear alkylene group may in the broadest sense also be described as “branched”. Thus, the term “linear alkylene group” does according to the invention preferably also encompass “branched alkylene groups”. However, they do not in any case contain ring systems.

When D represents R₃, it is preferable that R₃ represents a linear alkylene group having 3 to 16 carbon atoms, preferably 3 to 8 carbon atoms, more preferably 3 to 6 carbon atoms, further preferably 3 or 4 carbon atoms, and that this alkylene group may optionally be mono- or polysubstituted. This alkylene group may preferably be substituted with at least one alkyl group, which preferably has 1 to 16 carbon atoms. Particularly preferably, the linear alkylene group is unsubstituted or is substituted with at least one alkyl group having 1 to 16 carbon atoms, preferably 1 to 10 carbon atoms, particularly preferably 1 to 5 carbon atoms, very particularly preferably 1 to 4 carbon atoms, likewise preferably 1 to 3 carbon atoms. If it is substituted, it will have at least one tertiary, but potentially also at least one quaternary, carbon atom. Particularly preferably, the linear alkylene group R₃ is unsubstituted or is substituted with one to three alkylene groups. When there is more than one substitution, this may be present on the same carbon atom (giving rise to a quaternary carbon atom) or on more than one carbon atom (giving rise to two tertiary carbon atoms) of the linear alkylene group R₃. Additionally preferably, the linear alkylene group R₃ is unsubstituted or is substituted with one to three methyl groups. Very particularly preferably, R₃ is selected from —CH₂—CH₂—CH₂—, —CH₂—CH₂—CH₂—CH₂—, —CH₂—CH₂—CH₂—CH₂—CH₂—, —CH₂—CH₂—CH₂—CH₂—CH₂—CH₂—, —CH₂—CH₂—CH₂—CH₂—CH₂—CH₂—CH₂—, —CH₂—CH₂—CH₂—CH₂—CH₂—CH₂—CH₂—CH₂—, —CH₂—C(CH₃)₂—CH₂—, —CH₂—CH(CH₃)—CH₂—C(CH₃)₂—, —CH₂—C(CH₃)₂—CH₂—CH(CH₃)—, and —CH(CH₃)—CH₂—CH₂—C(CH₃)₂—. Likewise preferably, R₃ is selected from —CH₂—CH₂—CH₂—CH₂—, —CH₂—C(CH₃)₂—CH₂—, —CH₂—CH(CH₃)—CH₂—C(CH₃)₂—, —CH₂—C(CH₃)₂—CH₂—CH(CH₃)—, and —CH(CH₃)—CH₂—CH₂—C(CH₃)₂—. Very particularly preferably, R₃ represents —CH₂—C(CH₃)₂—CH₂—.

When D represents one of the formulas (1a) or (1b), it is preferable that
B in each case independently represents a CH₂ group, O or S, preferably a CH₂ group,
R₁ in each case independently represents a single bond or a linear alkylene group having 1 to 10 carbon atoms, particularly preferably a single bond, and
R₂ in each case independently represents a linear alkyl group having 1 to 10 carbon atoms, preferably 1 to 9 carbon atoms, more preferably 1 to 8 carbon atoms,
n is a number between 0 and 3, preferably between 0 and 2, particularly preferably between 0 and 1, very particularly preferably 1,
m is a number between 0 and 6, preferably between 0 and 3, particularly preferably between 0 and 2, very particularly preferably 0, and “*” indicate the positions at which the —(C═O)OA groups in formula (1) are present.

From the number for m it can already be seen that in formulas (1a) and (1b) it is possible for two R₂ to be present on one carbon atom each or else for one R₁-* and one R₂ to be present on one carbon atom each. It is also possible for always just one substituent R₁-* or R₂ to be present on one carbon atom.

In particular, it is preferable that the cycloaliphatic dicarboxylic acid is hydrogenated dimer fatty acid or the dicarboxylic acids of the compound of formula (IIa) or (IIb) or mixtures thereof. Hydrogenated dimer fatty acids are known to those skilled in the art. In particular, it is known that this can be a mixture of different compounds. This mixture may also comprise cycloaliphatic and linear compounds. These are according to the invention encompassed by the use of at least one linear aliphatic dicarboxylic acid and at least one cycloaliphatic dicarboxylic acid.

Preference is thus given to using hydrogenated dimer fatty acid as the linear aliphatic and/or cycloaliphatic dicarboxylic acid of the invention.

The at least one linear aliphatic dicarboxylic acid is particularly preferably selected from the group consisting of 2,2,4-trimethyladipic acid, 2,4,4-trimethyladipic acid, 2,2,5-trimethyladipic acid, and 3,3-dimethylglutaric acid. It is very particularly preferably 3,3-dimethylglutaric acid.

The at least one cycloaliphatic dicarboxylic acid is particularly preferably selected from the group consisting of cyclohexane-1,4-dicarboxylic acid, cyclohexane-1,3-dicarboxylic acid, cyclohexane-1,2-dicarboxylic acid, tetrahydrofuran-2,5-dicarboxylic acid, tetradihydrodimethylfuran-2,5-dicarboxylic acid, decahydronaphthalene-2,4-dicarboxylic acid, decahydronaphthalene-2,5-dicarboxylic acid, decahydronaphthalene-2,6-dicarboxylic acid, decahydronaphthalene-2,7-dicarboxylic acid, and hydrogenated dimer fatty acid. The at least one cycloaliphatic dicarboxylic acid is also preferably selected from the group consisting of cyclohexane-1,4-dicarboxylic acid, cyclohexane-1,3-dicarboxylic acid, cyclohexane -1,2-dicarboxylic acid, tetrahydrofuran-2,5-dicarboxylic acid, tetradihydrodimethylfuran-2,5-dicarboxylic acid, decahydronaphthalene-2,4-dicarboxylic acid, decahydronaphthalene-2,5-dicarboxylic acid, decahydronaphthalene-2,6-dicarboxylic acid, and decahydronaphthalene-2,7-dicarboxylic acid. Any desired mixtures may also be used. Very particularly preferably it is cyclohexane-1,4-dicarboxylic acid, cyclohexane-1,3-dicarboxylic acid or cyclohexane-1,2-dicarboxylic acid.

In particular, it is further preferable that a mixture of a linear aliphatic dicarboxylic acid and a cycloaliphatic dicarboxylic acid is used. It is particularly preferable that the at least one linear aliphatic dicarboxylic acid is selected from the group consisting of 2,2,4-trimethyladipic acid, 2,4,4-trimethyladipic acid, 2,2,5-trimethyladipic acid and 3,3-dimethylglutaric acid and that the at least one cycloaliphatic dicarboxylic acid is selected from the group consisting of cyclohexane-1,4-dicarboxylic acid, cyclohexane-1,3-dicarboxylic acid, cyclohexane-1,2-dicarboxylic acid, tetrahydrofuran-2,5-dicarboxylic acid, tetradihydrodimethylfuran-2,5-dicarboxylic acid, decahydronaphthalene-2,4-dicarboxylic acid, decahydronaphthalene-2,5-dicarboxylic acid, decahydronaphthalene-2,6-dicarboxylic acid, decahydronaphthalene-2,7-dicarboxylic acid, and hydrogenated dimer fatty acid. Particular preference is given to a mixture of 3,3-dimethylglutaric acid and 1,4-cyclohexanedicarboxylic acid, cyclohexane-1,3-dicarboxylic acid or cyclohexane-1,2-dicarboxylic acid.

Those skilled in the art know how the dicarboxylic acids used need to be inserted in formulas (1), (1a), (1b), (Ia), and (Ib) in order to obtain the corresponding diester of the invention.

In a preferred embodiment, the aliphatic, preferably cycloaliphatic diester of formula (Ia) or (Ib) is separated from the mixture from process step (i) by distillation.

This was particularly surprising, since it could not be assumed that the aliphatic, preferably cycloaliphatic diester would be readily distillable and that a good yield would be achieved despite the thermal stress.

Since a distillation is moreover relatively straightforward, a corresponding workup can be employed also in pre-existing industrial plants.

Step (i) of the process of the invention involves reacting a mixture comprising at least one linear aliphatic dicarboxylic acid and/or at least one cycloaliphatic dicarboxylic acid and at least one aliphatic and/or aromatic carbonate, in the presence of at least one first catalyst, to form a cycloaliphatic diester of formula (1), preferably formulas (Ia) or (Ib). This reaction is illustrated below using the reaction of a cyclohexanedioic acid with diphenyl carbonate (DPC) as an example. The invention is however not restricted to these specific compounds, although they are preferred. Those skilled in the art are capable of transposing the reaction and the corresponding elucidations to other of the described compounds.

In step (i), the following reaction (shown by way of example) takes place:

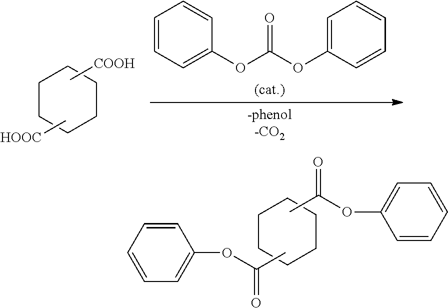

In the reaction, carbon dioxide and phenol (or a compound A-OH, where A is as defined in formula (1), preferably as defined in formulas (Ia) and (Ib)) is thus liberated. It has in accordance with the invention been found to be advantageous when this condensation product A-OH is removed during reaction step (i). Here, the expression “during step (i)” can mean that removal is begun immediately at the start of process step (i) or not until a certain time after step (i) has been commenced. Removal may take place in a manner known to those skilled in the art, preferably by applying a negative pressure appropriate to the reaction conditions. It must however be ensured here that the temperature and negative pressure in process step (i) are selected such that the aliphatic and/or aromatic carbonate as reactant and preferably initially also the cycloaliphatic diester as product is not also removed from the reaction mixture.

In addition, process step (i) of the invention preferably comprises at least one, particularly preferably all, of the following steps (ia) to (id):

(ia) Melting of the at least one linear aliphatic dicarboxylic acid and/or at least one cycloaliphatic dicarboxylic acid, preferably of the at least one cycloaliphatic dicarboxylic acid, and of the aliphatic and/or aromatic carbonate. This is preferably done under an inert gas atmosphere, preferably under nitrogen and/or argon. Alternatively, melting may be carried out under reduced pressure.

Preference is according to the invention given to using the at least one aliphatic and/or aromatic carbonate in a molar excess in relation to the at least one linear aliphatic dicarboxylic acid and/or at least one cycloaliphatic dicarboxylic acid, preferably at least one cycloaliphatic dicarboxylic acid. Particular preference is given to using 2.01 to 2.5, more preferably 2.05 to 2.2, moles of the at least one aliphatic and/or aromatic carbonate per mole of the at least one linear aliphatic dicarboxylic acid and/or at least one cycloaliphatic dicarboxylic acid, preferably at least one cycloaliphatic dicarboxylic acid. This has the advantage in particular that a high yield can be achieved. Moreover, losses of carbonate, which can potentially occur as a result of the removal of the condensation product, can be compensated.

In one aspect of the invention, one or more stabilizers may be added to the melt in process step (ia). The aliphatic, preferably cycloaliphatic diester of the invention is exposed to high thermal stress during the reaction. In addition, it is preferable to carry out the entire reaction under conditions that are as oxygen-free as possible. Oxygen inevitably leads to the formation of oxidation products. To minimize this formation, stabilizers and/or antioxidants may also be employed.

(ib) Heating of the mixture, preferably the melt obtained from step (ia). The mixture is preferably heated to 150° C. to 300° C., more preferably to 180° C. to 280° C., and particularly preferably to 190° C. to 240° C.

(ic) Reacting the mixture, preferably the mixture obtained from step (ib), with introduction of mixing energy, preferably by stirring. The reaction time in this step depends on the amount of the starting materials. The reaction time for step (ic) is by preference between 0.5 h to 24 h, preferably between 1 h and 18 h, and particularly preferably between 1.5 h and 10 h. The chosen reaction time should preferably be such that the carbonate is almost completely reacted. The progress of the reaction can be monitored in a manner known to those skilled in the art through the evolution of carbon dioxide (see reaction scheme above).

(id) Removing the condensation product A-OH, preferably from the mixture obtained from step (ic). It is accordingly preferable that the process of the invention is characterized in that, during the reaction in process step (i), volatiles having a boiling point below that of the aliphatic diester of formula (1), preferably of the cycloaliphatic diester of formula (Ia) or (Ib) and below that of the aliphatic and/or aromatic carbonate, are removed by distillation, optionally in stages. Removal in stages is the preferred option here when different volatiles are being removed. Opting for removal in stages is also preferred in order to ensure that volatiles are removed as completely as possible. The volatiles are preferably the compound A-OH, where A is as defined in formula (1), preferably as defined in formulas (Ia) and (Ib). These are preferably a substituted or unsubstituted phenol, when A represents a substituted or unsubstituted phenyl group.

The condensation product is preferably removed at temperatures of 150° C. to 250° C., more preferably 180° C. to 230° C. The vacuum during removal is further preferably 500 mbar to 0.01 mbar. It is particularly preferable for removal to be effected in stages by reducing the vacuum. Very particularly preferably, the vacuum in the final stage is 10 mbar to 0.01 mbar in order to remove phenol as condensation product.

The at least one cycloaliphatic dicarboxylic acid used in process step (i) is preferably selected from a compound of chemical formula (IIa) or (IIb) or mixtures thereof,

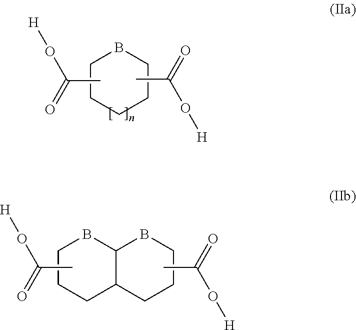

in which

B in each case independently represents a carbon atom or a heteroatom selected from the group consisting of O and S, preferably a CH₂ group or a heteroatom selected from the group consisting of O and S, and n is a number between 0 and 3. It is further preferable that B represents a carbon atom or O, preferably a CH₂ group or O, and n is a number between 0 and 3, preferably 0 or 1.

The at least one cycloaliphatic dicarboxylic acid in process step (i) is preferably selected from the group consisting of cyclohexane-1,4-dicarboxylic acid, cyclohexane-1,3-dicarboxylic acid, cyclohexane-1,2-dicarboxylic acid, tetrahydrofuran-2,5-dicarboxylic acid, tetradihydrodimethylfuran-2,5-dicarboxylic acid, decahydronaphthalene-2,4-dicarboxylic acid, decahydronaphthalene-2,5-dicarboxylic acid, decahydronaphthalene-2,6-dicarboxylic acid, decahydronaphthalene-2,7-dicarboxylic acid, and mixtures of these aliphatic dicarboxylic acids.

The cycloaliphatic dicarboxylic acid in process step (i) is further preferably selected from the group consisting of cyclohexane-1,4-dicarboxylic acid, cyclohexane-1,3-dicarboxylic acid, and cyclohexane-1,2-dicarboxylic acid and mixtures of these aliphatic dicarboxylic acids. The use of cyclohexane-1,4-dicarboxylic acid is most preferred.

The at least one aliphatic and/or aromatic carbonate used in process step (i) is preferably at least one aromatic carbonate. In the transesterification reaction to form polyester carbonates, cycloaliphatic diacids esterified with aliphatic alcohols exhibit low reactivity compared to aromatic alcohols, as a consequence of which the molecular weights of the corresponding polyester carbonates after the transesterification reaction are rather low. Such polymers accordingly exhibit only unsatisfactory properties. The use of aromatic carbonates is therefore particularly advantageous for the resulting polymer properties. Particular preference is given to using in process step (i) an aromatic carbonate of formula (III)

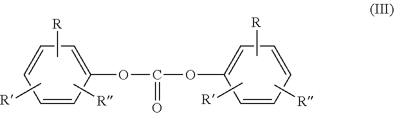

where R, R′, and R″ may each independently be identical or different and represent hydrogen, optionally branched C1-C34 alkyl, C7-C34 alkylaryl or C6-C34 aryl; in addition R may also denote —COO—R″′, where R′″ represents optionally branched C1-C34 alkyl, C7-C34 alkylaryl or C6-C34 aryl. Such carbonates have been described for example in EP-A 1 609 818. Preference is given to diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1 -phenylethyl)phenyl phenyl carbonate, and di[4-(1-methyl-1-phenylethyl)phenyl] carbonate. Very particular preference is given to using in process step (i) substituted or unsubstituted, preferably unsubstituted, diphenyl carbonate as the aromatic carbonate.

The carbonates may also be used with residual contents of the monohydroxyaryl compounds from which they were produced. The residual contents of the monohydroxyaryl compounds may be up to 20%, preferably 10%, particularly preferably up to 5%, and very particularly preferably up to 2%. This means that in the process of the invention it is possible also to use carbonates that do not need to undergo laborious purification after their production process. Since, in the process of the invention, the monohydroxyaryl compound from which the carbonate was obtained in turn occurs as condensation product A-OH and is preferably removed, these impurities do not interfere with the reaction. A carbonate produced in such an inexpensive manner allows the process of the invention to be made even more economically advantageous overall.

In another aspect, it is also possible to produce the at least one aliphatic and/or aromatic carbonate without the use of phosgene. This makes it possible to execute the entire polyester carbonate production process without the use of phosgene.

It has been found that, in accordance with the invention, the presence of at least one first catalyst that is basic is necessary in process step (i). Without this, the reaction between carbonate and diacid does not take place. This demonstrates the inability to transpose reaction conditions based on linear aliphatic dicarboxylic acid to the reaction of cycloaliphatic dicarboxylic acids, given that WO 02/10111 A1 describes the reaction of DPC with linear aliphatic dicarboxylic acids at temperatures of 180° C., this reaction also being preferred. It is reported that reaction products obtained in the presence of a basic catalyst have more impurities.

It has now in accordance with the invention been found that in the reaction with linear aliphatic and/or cycloaliphatic dicarboxylic acids, preferably cycloaliphatic dicarboxylic acids, a catalyst is necessary at least at moderate temperatures and that products of high purity can nevertheless be obtained with the process of the invention.

The first catalyst is a base or a basic transesterification catalyst. The following bases and catalysts may by way of example be used here:

Alkali metal compounds, such as LiOH, NaOH, KOH, CsOH, Li₂CO₃, Na₂CO₃, K₂CO₃, Cs₂CO₃, LiOAc, NaOAc, KOAc, CsOAc, alkaline earth metal compounds, such as Ca(OH)₂, Ba(OH)₂, Mg(OH)₂, Sr(OH)₂, CaCO₃, BaCO₃, MgCO₃, SrCO₃, Ca(OAc)₂, Ba(OAc)₂, Mg(OAc)₂, Sr(OAc)₂, inorganic or organic basic compounds, for example halides, phenoxides (such as Na phenoxide), diphenoxides, fluorides, phosphates, hydrogen phosphates, and borates of lithium, sodium, potassium, cesium, calcium, barium, magnesium, nitrogen bases and phosphorus bases, for example tetramethylammonium hydroxide, tetramethylammonium acetate, tetramethylammonium fluoride, tetramethylammonium tetraphenylborate, tetraphenylphosphonium fluoride, tetraphenylphosphonium tetraphenylborate, dimethyldiphenylammonium hydroxide, tetraethylammonium hydroxide, DBU, DBN or guanidine systems, for example 1,5,7-triazabicyclo[4.4.0]dec-5-ene, 7-phenyl-1,5,7-triazabicyclo[4.4.0]dec-5-ene, 7-methyl-1,5,7-triazabicyclo[4.4.0]dec-5-ene, 7,7′-hexylidenedi-1,5,7-triazabicyclo[4.4.0]dec-5-ene, 7,7′-decylidenedi-1,5,7-triazabicyclo[4.4.0]dec-5-ene, 7,7′-dodecylidenedi-1,5,7-triazabicyclo[4.4.0]dec-5-ene, or phosphazenes, for example the phosphazene base P1-t-oct=tert-octyliminotris(dimethylamino)phosphorane, the phosphazene base P1-t-butyl=tert-butyliminotris(dimethylamino)phosphorane, and BEMP=2-tert-butylimino-2-diethylamino-1,3 -dimethylperhydro-1,3,2-diaza-2-phosphorane. Further tetramethylammonium hydroxide, tetramethylammonium acetate, tetramethylammonium fluoride, tetramethylammonium tetraphenylborate, dimethyldiphenylammonium hydroxide, tetraethylammonium hydroxide, cetyltrimethylammonium tetraphenylborate, and cetyltrimethylammonium phenoxide. Also suitable are phosphonium catalysts of formula (IV):

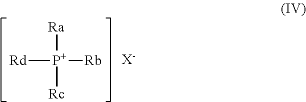

where Ra, Rb, Rc, and Rd may be identical or different C1-C10 alkyls, C6-C14 aryls, C7-C15 arylalkyls or C5-C6 cycloalkyls, preferably methyl or C6-C14 aryls, more preferably methyl or phenyl, and X- may be an anion such as hydroxide, sulfate, hydrogen sulfate, hydrogen carbonate, carbonate or a halide, preferably chloride or an alkoxide or aryloxide of formula —OR, where R may be C6-C14 aryl, C7-C15 arylalkyl or C5-C6 cycloalkyl, preferably phenyl. In addition, transesterification catalysts such as titanium alkoxides, such as titanium tetrabutoxide, tertiary amines, such as triethylamine, DMF, dimethylacetamide, methylpyrrolidone, tetramethylurea, dimethylimidazolidone hexaalkylguanidinium-halogens. Further AlCl₃, FeCl₃, BiCl₃, GaCl₃, SbCl₅, BF₃, Bi(OTf)₃, TiCl₄, ZrCl₄, TiBr₄ or ZrBr₄. Preferred catalysts are tetraphenylphosphonium chloride, tetraphenylphosphonium hydroxide, tetraphenylphosphonium phenoxide, sodium phenoxide, and 4-dimethylaminopyridine, particular preference among these being given to tetraphenylphosphonium phenoxide. The catalysts may also be used in any desired combination (two or more) with one another. Co-catalysts may in particular additionally also be used in order to increase the rate of the transesterification. These include for example the abovementioned alkaline salts of alkali metals and/or alkaline earth metals.

Preference as the first catalyst is given to cesium carbonate, sodium phenoxide, sodium benzoate, and 4-dimethylaminopyridine and also to mixtures of these substances, particular preference being given to sodium phenoxide and 4-dimethylaminopyridine. The use of sodium phenoxide in the form of the trihydrate is also preferred.

These first catalysts are preferably used in amounts of from 0.005% to 0.2% by weight, more preferably from 0.01% to 0.1% by weight, in each case based on all of the components used in process step (i).

The reaction in process step (i) is preferably carried out at temperatures from 180 to 280° C. This temperature is preferably established or maintained in process steps (ib) to (id), if employed.

In process step (ii) of the invention, the aliphatic, preferably cycloaliphatic, diester of formula (1), preferably of formula (Ia) or (Ib), is separated from the mixture from process step (i), preferably by distillation. The term “distillation” is known per se to those skilled in the art as a thermal separation process. The separating action of distillation is based on the unequal distribution of components over the gas and liquid phase at established thermodynamic equilibrium. Distillation is particularly suitable when the boiling points of the liquids to be separated are different/when the liquids have different vapor pressures at the same temperature. Those skilled in the art know how to carry out such a separation by distillation and how to design the appropriate apparatus, taking into account the deviations from the ideal thermodynamic equilibrium.

In particular, the term distillation is understood to include the processes of rectification, fractional distillation, vacuum distillation or azeotropic distillation and any desired combinations of these processes or with other thermal separation processes, for example adsorption/desorption processes and stripping. Options for intensifying the process, for example by using dividing wall columns, reactive dividing wall columns, or the possibility of reactive distillation, are known to those skilled in the art.

Preference is according to the invention given to carrying out the distillation in process step (ii) at pressures of 10 mbar or less, preferably at <5 mbar, particularly preferably at 4 mbar to 0.001 mbar, very particularly preferably at 2 mbar to 0.01 mbar. This has the advantage of keeping thermal stress on the product as low as possible, thus allowing undesired decomposition reactions and side reactions to be minimized.

Preference is according to the invention also given to carrying out the distillation in process step (ii) at a temperature of 180° C. to 280° C., particularly preferably at 200° C. to 260° C., very particularly preferably at 201° C. to 260° C. This temperature range should preferably be combined with the abovementioned pressure so as to further minimize the undesired decomposition reactions and side reactions. Given that a loss of mass had previously been observed for cyclohexane-1,4-dicarboxylic acid in thermogravimetric analyses at temperatures above 200° C., it was especially surprising that the distillation according to the invention at these temperatures is associated with high yields and high purity.

Process steps (i) and (ii) are according to the invention both preferably carried out in the absence of an additional organic solvent. This does not according to the invention exclude the possibility that both the at least one carbonate used and the condensation product formed in the reaction may be present as solvent in these reaction steps (where possible). This is the case particularly when the carbonate is used in a stoichiometric excess in relation to the dicarboxylic acid. This preferred process variant is particularly gentle. It is however according to the invention preferable that no additional organic solvent is added to the process. Process steps (i) and (ii) are particularly preferably carried out in the absence of methylene chloride, methanol, and toluene. The absence of an additional organic solvent allows the process to be carried out inexpensively and in an environmentally friendly manner.

In process step (iii), the cycloaliphatic diester of formula (Ia) or (Ib) from process step (i) that is separated in process step (ii), at least one dihydroxy compound, and at least one diaryl carbonate are reacted in a melt transesterification process in the presence of a mixture comprising a second catalyst and a third catalyst, wherein the second catalyst is a tertiary nitrogen base, wherein the third catalyst is a basic alkali metal salt, and wherein the proportion of alkali metal cations in process step (iii) is 0.0010% to 0.003% by weight based on all components used in process step (iii).

There are no particular restrictions on the reaction conditions of the melt transesterification, provided they are suitable for producing a corresponding polyester carbonate. For example, the reaction temperature may be within a range from 100° C. to 350° C., preferably 180° C. to 310° C. The pressure may in particular be reduced in the subsequent course of the process. The reaction time may vary between 1 h to 10 h. The polymerization may here be carried out in one or more stages, as known from the prior art.

As already described above, this process of the invention for producing a polyester carbonate surprisingly afforded polymers that have a light inherent color and are transparent and not brittle.

In particular, it is according to the invention advantageous when process step (iii) is carried out immediately after process step (ii). Here, the expression “immediately” is to be understood to mean that, after the production of the diester of the invention and the distillation thereof, the product obtained from the distillation is put into the melt transesterification process. It may as a consequence be necessary to only partially condense the product or only partially remove the thermal energy therefrom, since in the melt transesterification process a molten product is required. The thermal energy accordingly does not need to be applied twice. It is also possible for the heat arising in the condensation of the distilled product to be supplied to the melt transesterification process via suitable means, so as to thus design an economical and environmentally friendly process.

The at least one dihydroxy compound in process step (iii) is preferably selected from the group consisting of cyclohexane-1,2-diol, cyclohexane-1,3-diol, cyclohexane-1,4-diol, cyclohexane-1,2-dimethanol, cyclohexane-1,3-dimethanol, cyclohexane-1,4-dimethanol, tricyclodecanedimethanol, 3,9-bis(1,1-dimethyl-2-hydroxyethyl)-2,4,8,10-tetraoxaspiro[5.5]undecane, 2,2-bis(4-hydroxycyclohexyl)propane, tetrahydrofuran-2,5-dimethanol, bisphenol A, 1,1-bis(4-hydroxyphenyl)-3,3,5-trimethylcyclohexane, 4,4′-dihydroxybiphenyl (DOD), 4,4′-dihydroxydiphenyl ether (DOD ether), bisphenol B, bisphenol M, the bisphenols (V) to (VII)

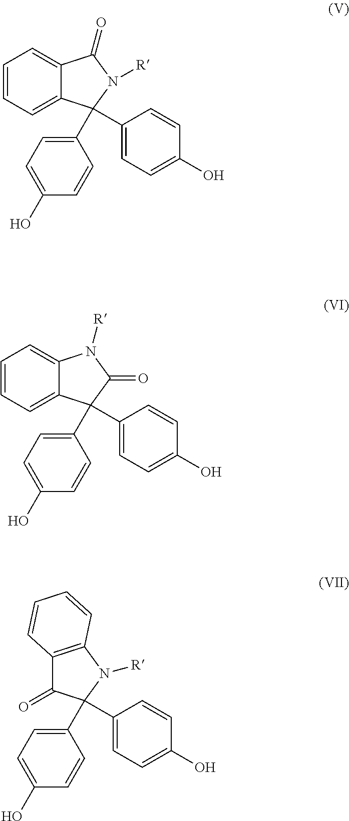

where in formulas (V) to (VII) R′ in each case represents C₁-C₄ alkyl, aralkyl or aryl, preferably methyl or phenyl, very particularly preferably methyl,
and also butanediol, ethylene glycol, hexanediol and 1,4:3,6-dianhydrohexitols such as isomannide, isoidide, and isosorbide. These are also known as 1,4:3,6-dianhydro-D-glycidol, 1,4:3,6-dianhydro-L-iditol, and 1,4:3,6-dianhydro-D-mannitol. Particular preference is given here to aliphatic dihydroxy compounds. In one embodiment here, in addition to the aliphatic dihydroxy compound(s) it is possible to use an aromatic dihydroxy compound in a molar deficit.

The dihydroxy compound is very particularly preferably a 1,4:3,6-dianhydrohexitol such as isomannide, isoidide, and isosorbide, greatest preference among these being given to isosorbide. Any desired mixtures may also be used. The dihydroxy compound is also preferably a mixture of 1,4:3,6-dianhydrohexitols, such as isomannide, isoidide, and isosorbide, and at least one from the group consisting of cyclohexane-1,2-dimethanol, cyclohexane-1,3-dimethanol and/or cyclohexane-1,4-dimethanol. In this case it is particularly preferable that the cyclohexane-1,2-dimethanol, cyclohexane-1,3-dimethanol and/or cyclohexane-1,4-dimethanol is used in amounts of up to 20%, preferably 1 to 10%, based on the total mass of the dihydroxy compounds.

It is also preferable that a compound of formula (III) is used as the diaryl carbonate in process step (iii)

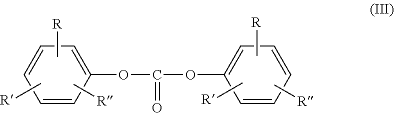

where R, R′, and R″ may each independently be identical or different and represent hydrogen, optionally branched C1-C34 alkyl, C7-C34 alkylaryl or C6-C34 aryl; in addition R may also denote —COO—R″′, where R′″ represents optionally branched C1-C34 alkyl, C7-C34 alkylaryl or C6-C34 aryl. The preferences already described above in relation to formula (III) apply here too. It has proved advantageous here to produce the cycloaliphatic diester of the invention using the same carbonate—for example DPC—that is used to produce the polymer in process step (b). Small traces of the DPC cited by way of example then interfere in process step (b), since DPC is then in any case added in process step (b). This method of production using DPC is accordingly very advantageous. Otherwise, all reagents and by-products must be removed very exactly before the polymerization.

The tertiary nitrogen base used as the second catalyst in process step (iii) is preferably selected from bases derived from guanidine, 4-dimethylaminopyridine (DMAP), 1,8-diazabicyclo[5.4.0]undec-7-ene, 1,5-diazabicyclo[4.3.0]non-5-ene, 1,5,7-triazabicyclo[4.4.0]dec-5-ene, hexamethylphosphorimide triamide, 1,2-dimethyl-1,4,5,6-tetrahydropyridine, 7-methyl-1,5,7-triazabicyclodec-5-ene, 1,8-diazabicyclo[5.4.0]undec-7-ene (DBU), DBN, ethylimidazole, N,N-diisopropylethylamine (Hünig's base), pyridine, TMG, and mixtures of these substances. Further preferably, the second catalyst is selected from bases derived from guanidine, 4-dimethylaminopyridine (DMAP), 1,8-diazabicyclo[5.4.0]undec-7-ene, 1,5-diazabicyclo[4.3.0]non-5-ene, 1,5,7-triazabicyclo[4.4.0]dec-5-ene and mixtures of these substances. Particular preference is given to using 4-dimethylaminopyridine.

It has been found to be advantageous when the tertiary nitrogen base according to the invention, in particular DMAP, can be removed from the system by applying a negative pressure. This allows this catalyst to be effectively and easily removed from the system.

The second catalyst used in process step (iii) is preferably used in an amount of from 0.005% to 0.02% by weight based on all components used in process step (iii).

The alkali metal cations present in process step (iii) are preferably lithium cations, potassium cations, sodium cations, cesium cations, and mixtures thereof.

The third catalyst used in process step (iii) is the organic or inorganic alkali metal or alkaline earth metal salt of a weak acid (pKa between 3 and 7 at 25° C.). Suitable weak acids are for example carboxylic acids, preferably C2-C22 carboxylic acids, such as acetic acid, propionic acid, oleic acid, stearic acid, lauric acid, benzoic acid, 4-methoxybenzoic acid, 3-methylbenzoic acid, 4-tert-butylbenzoic acid, p-tolueneacetic acid, 4-hydroxybenzoic acid, salicylic acid, partial esters of polycarboxylic acids, such as monoesters of succinic acid, branched aliphatic carboxylic acids, such as 2,2-dimethylpropanoic acid, 2,2-dimethylpropanoic acid, 2,2-dimethylbutanoic acid, and 2-ethylhexanoic acid.

Suitable organic and inorganic salts are or are derived from sodium hydrogen carbonate, potassium hydrogen carbonate, lithium hydrogen carbonate, sodium carbonate, lithium carbonate, potassium carbonate, sodium acetate, potassium acetate, lithium acetate, sodium stearate, potassium stearate, lithium stearate, sodium oleate, lithium oleate, potassium oleate, sodium benzoate, potassium benzoate, lithium benzoate, and the disodium, dipotassium, and dilithium salts of BPA. It is also possible to use calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate and corresponding oleates. The use of corresponding salts of phenols, in particular of phenol, is additionally possible. These salts may be used individually or as a mixture.

The third catalyst used in process step (iii) is preferably selected from the group consisting of sodium hydroxide, lithium hydroxide, sodium phenoxide, lithium phenoxide, sodium benzoate, lithium benzoate, and cesium carbonate and mixtures of these substances. Particular preference is given to using sodium phenoxide or lithium phenoxide. The use of sodium phenoxide in the form of the trihydrate is also preferred here.

The third catalyst used in process step (iii) is further preferably selected from the group consisting of sodium hydroxide, sodium phenoxide, sodium benzoate, and cesium carbonate and mixtures of these substances. Particular preference is given to using sodium phenoxide. The use of sodium phenoxide in the form of the trihydrate is also preferred here.

In one further aspect of the invention, a polyester carbonate is provided that is obtained by the process of the invention for producing a polyester carbonate by means of a melt transesterification process in all of the configurations and preferences described above.

The polyester carbonate of the invention can be processed as such into moldings of all kinds. It can also be processed into thermoplastic molding compounds with other thermoplastics and/or polymer additives. The molding compounds and moldings are further provided by the present invention.

The polymer additives are preferably selected from the group consisting of flame retardants, anti-drip agents, flame retardant synergists, smoke inhibitors, lubricants and demolding agents, nucleating agents, antistats, conductivity additives, stabilizers (e.g. hydrolysis, heat aging and UV stabilizers and also transesterification inhibitors), flow promoters, phase compatibilizers, dyes and pigments, impact modifiers and also fillers and reinforcers.

The thermoplastic molding compounds may be produced for example by mixing the polyester carbonate and the other constituents and melt-compounding and melt-extruding the resulting mixture at temperatures of preferably 200° C. to 320° C. in customary apparatuses, for example internal kneaders, extruders and twin-shaft screw systems, in a known manner. This process is in the context of the present application generally referred to as compounding. The term “molding compound” is thus to be understood as meaning the product obtained when the constituents of the composition are melt-compounded and melt-extruded.

The moldings obtained from the polyester carbonate of the invention or from the thermoplastic molding compounds comprising the polyester carbonate can be produced for example by injection molding, extrusion, and blow-molding processes. A further form of processing is the production of moldings by thermoforming from previously produced sheets or films.

Embodiments 0 to 23 of the present invention are described hereinbelow.

0. A process for preparing a polyester carbonate comprising the steps of:
(i) reacting a mixture comprising at least one linear aliphatic dicarboxylic acid and/or at least one cycloaliphatic dicarboxylic acid and at least one aliphatic and/or aromatic carbonate, in the presence of at least one first catalyst that is basic, to form an aliphatic diester of formula (1)

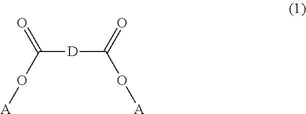

in which
A in each case independently represents an aliphatic or aromatic radical,
   D represents R₃ or one of formulas (1a) or (1b),
where R₃ represents a linear alkylene group having 3 to 16 carbon atoms, preferably 3 to 8 carbon atoms, more preferably 3 to 6 carbon atoms, further preferably 3 or 4 carbon atoms, and this alkylene group may optionally be mono- or polysubstituted or

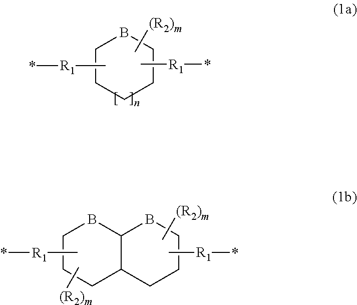

in which
B in each case independently represents a CH₂ group, O or S,
R₁ in each case independently represents a single bond or an alkylene group having 1 to 10 carbon atoms, preferably a single bond or an alkylene group having 1 to 9 carbon atoms, more preferably a single bond or an alkylene group having 1 to 8 carbon atoms, likewise preferably a single bond or an alkylene group having 1 to 5 carbon atoms, particularly preferably a single bond, and
R₂ in each case independently represents an alkyl group having 1 to 10 carbon atoms, preferably 1 to 9 carbon atoms, more preferably 1 to 8 carbon atoms,
n is a number between 0 and 3, preferably between 0 and 2, particularly preferably between 0 and 1, very particularly preferably 1,
m is a number between 0 and 6, preferably between 0 and 3, particularly preferably between 0 and 2, very particularly preferably 0, and “*” indicate the positions at which the —(C═O)OA groups in formula (1) are present,
(ii) separating the aliphatic diester of formula (1) from the mixture from process step (i), (iii) reacting the separated aliphatic diester of formula (1), at least one dihydroxy compound, and at least one diaryl carbonate in a melt transesterification process in the presence of a mixture comprising a second catalyst and a third catalyst,
wherein the second catalyst is a tertiary nitrogen base,
wherein the third catalyst is a basic alkali metal salt,
and wherein the proportion of alkali metal cations in process step (iii) is 0.0010% to 0.0030% by weight based on all components used in process step (iii).

1. A process for preparing a polyester carbonate comprising the steps of:
(i) reacting a mixture comprising at least one cycloaliphatic dicarboxylic acid and at least one aliphatic and/or aromatic carbonate, in the presence of at least one first catalyst that is basic, to form a cycloaliphatic diester of formula (Ia) or (Ib)

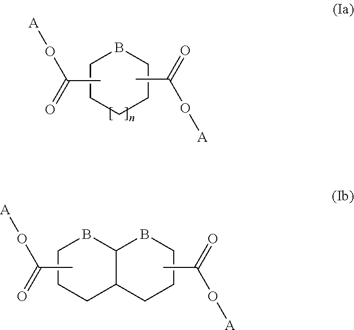

in which
A in each case independently represents an aliphatic or aromatic radical,
B in each case independently represents a carbon atom or a heteroatom selected from the group consisting of O, S, and N, and
n is a number between 0 and 3,
(ii) separating the cycloaliphatic diester of formula (Ia) or (Ib) from the mixture from process step (a),
(iii) reacting the separated cycloaliphatic diester of formula (Ia) or (Ib), at least one dihydroxy compound, and at least one diaryl carbonate in a melt transesterification process in the presence of a mixture comprising a second catalyst and a third catalyst,
wherein the second catalyst is a tertiary nitrogen base,
wherein the third catalyst is a basic alkali metal salt,
and wherein the proportion of alkali metal cations in process step (iii) is 0.0010% to 0.003% by weight based on all components used in process step (iii).

2. The process according to embodiment 0 or 1, characterized in that the separation in process step (ii) is effected by distillation.

3. The process according to embodiment 2, characterized in that the distillation in process step (ii) is carried out at a temperature of 180° C. to 280° C.

4. The process according to any of the preceding embodiments, characterized in that B in formulas (Ia) and (Ib) represents a carbon atom, preferably a CH₂ group.

5. The process according to any of the preceding embodiments, characterized in that the linear aliphatic dicarboxylic acid used in process step (i) is selected from the group consisting of 2,2,4-trimethyladipic acid, 2,4,4-trimethyladipic acid, 2,2,5-trimethyladipic acid, and 3,3-dimethylglutaric acid.

6. The process according to any of the preceding embodiments, characterized in that the cycloaliphatic dicarboxylic acid used in process step (i) is selected from the group consisting of cyclohexane-1,4-dicarboxylic acid, cyclohexane-1,3-dicarboxylic acid, cyclohexane-1,2-dicarboxylic acid, tetrahydrofuran-2,5-dicarboxylic acid, tetradihydrodimethylfuran-2,5-dicarboxylic acid, decahydronaphthalene-2,4-dicarboxylic acid, decahydronaphthalene-2,5-dicarboxylic acid, decahydronaphthalene-2,6-dicarboxylic acid, decahydronaphthalene-2,7-dicarboxylic acid, and hydrogenated dimer fatty acid and mixtures of these aliphatic dicarboxylic acids.

7. The process according to embodiment 6, characterized in that the cycloaliphatic dicarboxylic acid is selected from the group consisting of cyclohexane-1,4-dicarboxylic acid, cyclohexane-1,3-dicarboxylic acid, and cyclohexane-1,2-dicarboxylic acid and mixtures of these aliphatic dicarboxylic acids.

8. The process according to any of the preceding embodiments, characterized in that, in process step (i), an aromatic carbonate of formula (III) is used

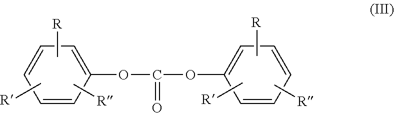

where R, R′, and R″ may each independently be identical or different and represent hydrogen, optionally branched C1-C34 alkyl, C7-C34 alkylaryl or C6-C34 aryl; in addition R may also denote —COO—R″′, where R′″ represents optionally branched C1-C34 alkyl, C7-C34 alkylaryl or C6-C34 aryl.

9. The process according to embodiment 8, characterized in that, in process step (i), diphenyl carbonate is used as the aromatic carbonate.

10. The process according to any of the preceding embodiments, characterized in that the first catalyst used in process step (i) is selected from the group consisting of cesium carbonate, sodium phenoxide, and 4-dimethylamine pyridine and mixtures of these substances.

11.The process according to any of the preceding embodiments, characterized in that the first catalyst used in process step (i) is used in an amount of from 0.005% to 0.2% by weight based on all of the components used in process step (i).

12. The process according to any of embodiments 1 to 11, characterized in that, during the reaction in process step (i), volatiles having a boiling point below that of the aliphatic diester of formula (1), preferably of the cycloaliphatic diester of formula (Ia) or (Ib) and below that of the aliphatic and/or aromatic carbonate, are removed by distillation, optionally in stages.

13.The process according to any of the preceding embodiments, characterized in that the second catalyst used in process step (iii) is used in an amount of from 0.005% to 0.02% by weight based on all components used in process step (iii).

14.The process according to any of the preceding embodiments, characterized in that the second catalyst used in process step (iii) is selected from the group consisting of bases derived from guanidine, 4-dimethylaminopyridine, 1,8-diazabicyclo[5.4.0]undec-7-ene, and 1,5-diazabicyclo[4.3.0]non-5-ene and mixtures of these substances.

15.The process according to any of the preceding embodiments, characterized in that the second basic catalyst used in process step (iii) is 4-dimethylaminopyridine.

16.The process according to any of the preceding embodiments, characterized in that the alkali metal cations in process step (iii) are selected from sodium cations, cesium cations, and mixtures thereof.

17.The process according to embodiment 16, characterized in that the third catalyst used in process step (iii) is selected from the group consisting of sodium hydroxide, lithium hydroxide, sodium phenoxide, lithium phenoxide, sodium benzoate, lithium benzoate, and cesium carbonate and mixtures of these substances.

18. The process according to any of the preceding embodiments, characterized in that the dihydroxy compound in process step (iii) is selected from the group consisting of cyclohexane-1,2-diol, cyclohexane-1,3-diol, cyclohexane-1,4-diol, cyclohexane-1,2-dimethanol, cyclohexane-1,3-dimethanol, cyclohexane-1,4-dimethanol, tricyclodecanedimethanol, 3,9-bis(1,1-dimethyl-2-hydroxyethyl)-2,4,8,10-tetraoxaspiro[5.5]undecane, 2,2-bis(4-hydroxycyclohexyl)propane, tetrahydrofuran-2,5-dimethanol, bisphenol A, 1,1-bis(4-hydroxyphenyl)-3,3,5-trimethylcyclohexane, 4,4′-dihydroxybiphenyl (DOD), 4,4′-dihydroxydiphenyl ether (DOD ether), bisphenol B, bisphenol M, the bisphenols (V) to (VII)

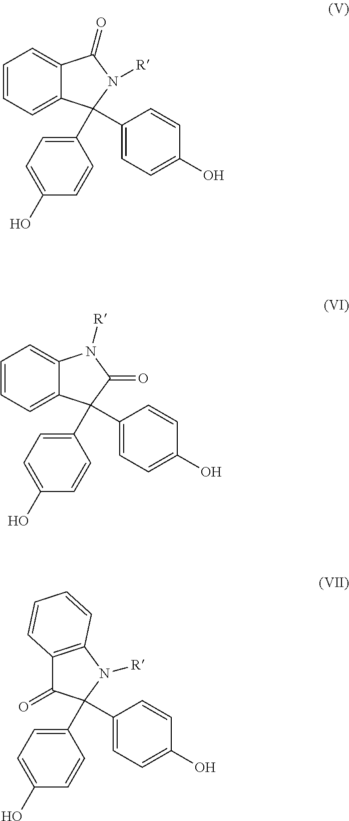

where in formulas (V) to (VII) R′ in each case represents C₁-C₄ alkyl, aralkyl or aryl, preferably methyl or phenyl, very particularly preferably methyl, and also butanediol, ethylene glycol, hexanediol and 1,4:3,6-dianhydrohexitols such as isomannide, isoidide, and isosorbide.

19. The process according to embodiment 13, characterized in that the dihydroxy compound in process step (iii) is selected from the group consisting of isomannide, isoidide, and isosorbide and mixtures of these substances.

20. The process according to any of the preceding embodiments, characterized in that a compound of formula (III) is used as the diaryl carbonate in process step (III)

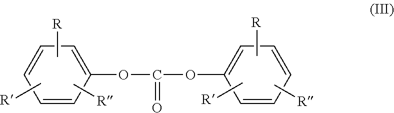

where R, R′, and R″ may each independently be identical or different and represent hydrogen, optionally branched C1-C34 alkyl, C7-C34 alkylaryl or C6-C34 aryl; in addition R may also denote —COO—R″′, where R″′ represents optionally branched C1-C34 alkyl, C7-C34 alkylaryl or C6-C34 aryl.

21. The process according to embodiment 15, characterized in that diphenyl carbonate is used in process step (iii).

22. A polyester carbonate obtainable by the process according to any of embodiments 1 to 21.

23. A thermoplastic molding compound comprising a polyester carbonate according to embodiment 22.

24. A molding comprising a polyester carbonate according to embodiment 22.

### EXAMPLES

### Materials Used

Cyclohexane-1,4-dicarboxylic acid: CAS 1076-97-7; purity 99%; Tokyo Chemical Industries, Japan

Diphenyl carbonate: Purity≥99.5%; CAS 102-09-0; Covestro NV, Antwerp, Belgium

Sodium phenoxide trihydrate: Purity 98%; CAS 652-67-5; Merck, Darmstadt, Germany

Isosorbide: CAS 652-67-5; Polysorb PSA; Roquette Frères, France

4-Dimethylaminopyridine: Purity≥98.0%; CAS 1122-58-3; Sigma-Aldrich, Munich, Germany

Cesium carbonate: Purity≥99.0%; CAS 534-17-8; Sigma-Aldrich, Munich, Germany

### Analytical Methods

Determination of solution viscosity: The relative solution viscosity (rel; also referred to as eta rel) was determined for a 1% by weight dichloromethane solution of the polyester carbonate versus dichloromethane at 25° C. using an Ubbelohde viscometer. The determination was carried out in accordance with DIN 51562-3; 1985-05. In this determination, the transit times of the polyester carbonate under investigation are measured by the Ubbelohde viscometer in order to then determine the difference in viscosity between the polymer solution and its solvent. For this, the Ubbelohde viscometer undergoes an initial calibration through measurement of the pure solvents dichloromethane, trichloroethylene, and tetrachloroethylene (always performing at least 3 measurements, but not more than 9 measurements). This is followed by the calibration proper with the solvent dichloromethane. The polymer sample is then weighed out, dissolved in dichloromethane and the flow time for this solution then determined in triplicate. The average of the flow times is corrected via the Hagenbach correction and the relative solution viscosity calculated.

Visual examination: The color and transparency of the polyester carbonate were assessed visually.

Purity of the diphenyl cyclohexane-1,4-dicarboxylate: The purity of the diphenyl cyclohexane-1,4-dicarboxylate was determined by gas chromatography with flame ionization detector (GC-FID).

### Example 1a—Preparation of Diphenyl cyclohexane-1,4-dicarboxylate and Separation, Process Steps (i) and (ii)

A 6-liter flask with distillation bridge, distillate collecting flask, and vacuum pump with cold trap was charged with 3156.28 g of diphenyl carbonate, 1208.04 g of cyclohexane-1,4-dicarboxylic acid, and 2.619 g of sodium phenoxide trihydrate and the mixture heated at 180° C. with stirring. The pressure was left at standard pressure. At 180° C. the initial evolution of CO₂ was observed. The CO₂ was continuously withdrawn from the flask while heating the reaction mixture to 200° C. over a 15-minute period and to 210° C. over a further 45-minute period. The reaction mixture was left at 210° C. for a further 135 minutes. Phenol was then removed from the reaction mixture by distillation under reduced pressure. Over a 60-minute period, at an overhead temperature of 170° C., the pressure was lowered from 700 mbar to 12 mbar, thereby ensuring steady removal of the phenol from the reaction mixture.

After the distillation under reduced pressure, 2285 g of reaction product remained in the flask. After cooling, the reaction product was dissolved in toluene (2 g of toluene per 1 g of reaction product) at 80° C. and the reaction product was recrystallized by cooling. Drying in a vacuum oven afforded 1332 g of diphenyl cyclohexane-1,4-dicarboxylate as a white powder. GC-FID analysis revealed a purity of 99.8% trans-diphenyl cyclohexane-1,4-dicarboxylate. The toluene containing secondary components was cooled to −18° C., resulting in the crystallization of a further 489 grams of product, which was separated off as a white solid.

### Example 1b: Polymerization of Isosorbide, Diphenyl Carbonate, and Diphenyl cyclohexane-1,4-dicarboxylate, Process Step (iii)

A three-necked flask with stirrer (from IKA), oil bath, short-path separator, vacuum connection, and cold trap was charged with 59.96 g of isosorbide, 51.73 g of diphenyl carbonate, and 57.04 g of diphenyl cyclohexane-1,4-dicarboxylate obtained from process step 1a.

Solutions of the appropriate catalysts in phenol were added to the initial charge. The catalyst solutions in each case consisted of 5% by weight of catalyst and 95% by weight of phenol. N,N-Dimethylaminopyridine was added to the reactants in the initial charge in an absolute content of 0.0090 g. This corresponds to 53.3 ppm (by weight) of catalyst based on the reactants used or 6.1 ppm (by weight) of nitrogen based on the reactants used.

Sodium phenoxide trihydrate was added to the reactants in the initial charge in an absolute content of 0.0225 g. This corresponds to 133.3 ppm by weight based on the reactants used or 18.0 ppm by weight of alkali metal based on the reactants used.

The reaction mixture was freed of oxygen by evacuating and releasing the vacuum with nitrogen three times and then melted at 170° C. and standard pressure until a homogeneous melt was present. The temperature of the reaction mixture was then increased to 180° C., the pressure cautiously lowered to 200 mbar, and the reaction mixture held at these parameters for 20 minutes. The temperature of the reaction mixture was then increased to 220° C., the pressure lowered to 50 mbar, and the stirring speed of the stirrer reduced. After a further 20-minute hold time, the pressure was lowered to 25 mbar and the stirring speed of the stirrer further reduced. After a further 15-minute hold time, the temperature of the reaction mixture was increased to 230° C. and the pressure lowered to 0.59 mbar. After a further 5-minute hold time, the temperature of the reaction mixture was increased to 240° C. and this was in turn held for 10 minutes. The vacuum was then released by introducing nitrogen and a sample of the product was taken from the flask.

A transparent product resulted. Visual examination revealed a slight yellow tinge. The relative solution viscosity was 1.22.

The polymerization of isosorbide, diphenyl carbonate, and diphenyl cyclohexane-1,4-dicarboxylate in examples 2b to 13b below was carried out in analogous manner to example 1b. In these experiments, the number of catalysts and their proportion by weight in ppm based on the amount of reactants used in this process step (iii) were varied. Details are shown in Table 1 below. The stated proportions by weight are in each case in ppm.

TABLE 1
Varying the catalysts in process step (iii)

| Experiment | | Cs₂CO₃ | DMAP | NaOPh•3H₂O | Alkali metal | | |
|---|---|---|---|---|---|---|---|
| No. | | [ppm] | [ppm] | [ppm] | [ppm] | Eta rel | Observations |
| 2b | non-inv. | 0 | 53.3 | 26.7 | 3.6 | 1.16 | light-colored and transparent product, brittle |
| 3b | non-inv. | 0 | 53.3 | 53.3 | 7.2 | 1.16 | light-colored and transparent product, brittle |
| 4b | inv. | 0 | 53.3 | 80.0 | 10.8 | 1.21 | light-colored and transparent product, not brittle |
| 5b | inv. | 0 | 53.3 | 106.6 | 14.4 | 1.22 | light-colored and transparent product, not brittle |
| 1b | inv. | 0 | 53.3 | 133.3 | 18.0 | 1.22 | light-colored and transparent product, not brittle |
| 6b | inv. | 0 | 53.3 | 186.6 | 25.2 | 1.20 | light-colored and transparent product, not brittle |
| 7b | non-inv. | 0 | 53.3 | 266.6 | 36.0 | 1.36 | opaque and brown-colored product |
| 8b | non-inv. | 0 | 0 | 133.3 | 18.0 | — | no polymerization |
| 9b | non-inv. | 2.0 | 0 | 0 | 1.6 | — | no polymerization |
| 10b | non-inv. | 133.3 | 0 | 0 | 108.7 | — | no polymerization |
| 11b | non-inv. | 667 | 0 | 0 | 544.1 | — | insoluble, brittle, and black-colored product |
| 12b | non-inv. | 0 | 0 | 667 | 90.1 | — | insoluble, brittle, and black-colored product |
| 13b | non-inv. | 0 | 667 | 0 | 0 | 1.05 | transparent and very brittle product |

inv.—example in accordance with the invention
non-inv.—example not in accordance with the invention

The data in Table 1 show that the object of the invention can be achieved only with the claimed process. If the amount of alkali metal in process step (iii) is too small (examples 2b and 3b), only inadequate polymer growth occurs. If the amount is too large (example 7b), this results in a polyester carbonate of inadequate quality.

If only one catalyst is used, no polymerization to the polyester carbonate occurs or a product of poor quality is obtained (examples 8b to 13b). It is also not possible to obtain a polyester carbonate with good properties by varying the amount of this one catalyst.

1.-15. (canceled)

16. A process for preparing a polyester carbonate comprising the steps of:
(i) reacting a mixture comprising at least one linear aliphatic dicarboxylic acid and/or at least one cycloaliphatic dicarboxylic acid and at least one aliphatic and/or aromatic carbonate, in the presence of at least one first catalyst that is basic, to form an aliphatic diester of formula (1) 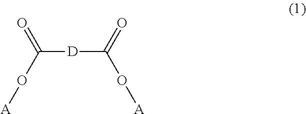
in which
A in each case independently represents an aliphatic or aromatic radical,
D represents R₃ or one of formulas (1a) or (1b),
where R₃ represents a linear alkylene group having 3 to 16 carbon atoms and this alkylene group may optionally be mono- or polysubstituted or 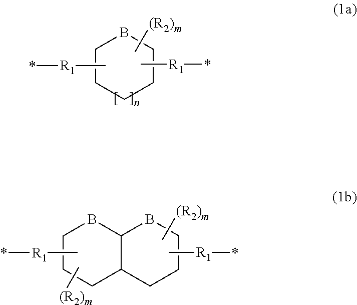
in which
B in each case independently represents a CH₂ group, O or S,
R₁ in each case independently represents a single bond or an alkylene group having 1 to 10 carbon atoms and
R₂ in each case independently represents an alkyl group having 1 to 10 carbon atoms,
n is a number between 0 and 3,
m is a number between 0 and 6 and “*” indicate the positions at which the
—(C═O)OA groups in formula (1) are present,
(ii) separating the aliphatic diester of formula (1) from the mixture from process step (i),
(iii) reacting the separated aliphatic diester of formula (1), at least one dihydroxy compound, and at least one diaryl carbonate in a melt transesterification process in the presence of a mixture comprising a second catalyst and a third catalyst,
wherein the second catalyst is a tertiary nitrogen base,
wherein the third catalyst is a basic alkali metal salt,
and wherein the proportion of alkali metal cations in process step (iii) is 0.0010% to 0.0030% by weight based on all components used in process step (iii).

17. The process as claimed in claim 16, wherein B in formulas (Ia) and (Ib) represents a CH₂ group.

18. The process as claimed in claim 17, wherein the cycloaliphatic dicarboxylic acid is selected from the group consisting of cyclohexane-1,4-dicarboxylic acid, cyclohexane-1,3-dicarboxylic acid, cyclohexane-1,2-dicarboxylic acid, and hydrogenated dimer fatty acid and mixtures of these aliphatic dicarboxylic acids.

19. The process as claimed in claim 16, wherein, in process step (i), an aromatic carbonate of formula (III) is used 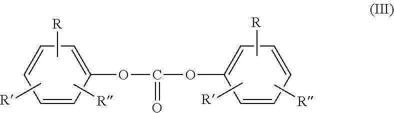
where R, R′, and R″ may each independently be identical or different and represent hydrogen, optionally branched C1-C34 alkyl, C7-C34 alkylaryl or C6-C34 aryl; in addition R may also denote —COO—R″′, where R″′ represents optionally branched C1-C34 alkyl, C7-C34 alkylaryl or C6-C34 aryl.

20. The process as claimed in claim 16, wherein the first catalyst used in process step (i) is selected from the group consisting of cesium carbonate, sodium phenoxide, and 4-dimethylamine pyridine and mixtures of these substances.

21. The process as claimed in claim 16, wherein the first catalyst used in process step (i) is used in an amount of from 0.005% to 0.2% by weight based on all of the components used in process step (i).

22. The process as claimed in claim 16, wherein the second catalyst used in process step (iii) is used in an amount of from 0.005% to 0.02% by weight based on all components used in process step (iii).

23. The process as claimed in claim 16, wherein the second catalyst used in process step (iii) is selected from the group consisting of bases derived from guanidine, 4-dimethylaminopyridine, 1,8-diazabicyclo[5.4.0]undec-7-ene, and 1,5-diazabicyclo[4.3.0]non-5-ene and mixtures of these substances.

24. The process as claimed in a claim 16, wherein the alkali metal cations in process step (iii) are selected from sodium cations, lithium ions, cesium cations, and mixtures thereof.

25. The process as claimed in claim 24, wherein the third catalyst used in process step (iii) is selected from the group consisting of sodium hydroxide, lithium hydroxide, sodium phenoxide, lithium phenoxide, sodium benzoate, lithium benzoate, and cesium carbonate and mixtures of these substances.

26. The process as claimed in claim 16, wherein the dihydroxy compound in process step (iii) is selected from the group consisting of cyclohexane-1,2-diol, cyclohexane-1,3-diol, cyclohexane-1,4-diol, cyclohexane-1,2-dimethanol, cyclohexane-1,3-dimethanol, cyclohexane-1,4-dimethanol, tricyclodecanedimethanol, 3,9-bis(1,1-dimethyl-2-hydroxyethyl)-2,4,8,10-tetraoxaspiro[5.5]undecane, 2,2-bis(4-hydroxycyclohexyl)propane, tetrahydrofuran-2,5-dimethanol, bisphenol A, 1,1-bis(4-hydroxyphenyl)-3,3,5-trimethylcyclohexane, 4,4′-dihydroxybiphenyl (DOD), 4,4′-dihydroxydiphenyl ether (DOD ether), bisphenol B, bisphenol M, the bisphenols (V) to (VII) 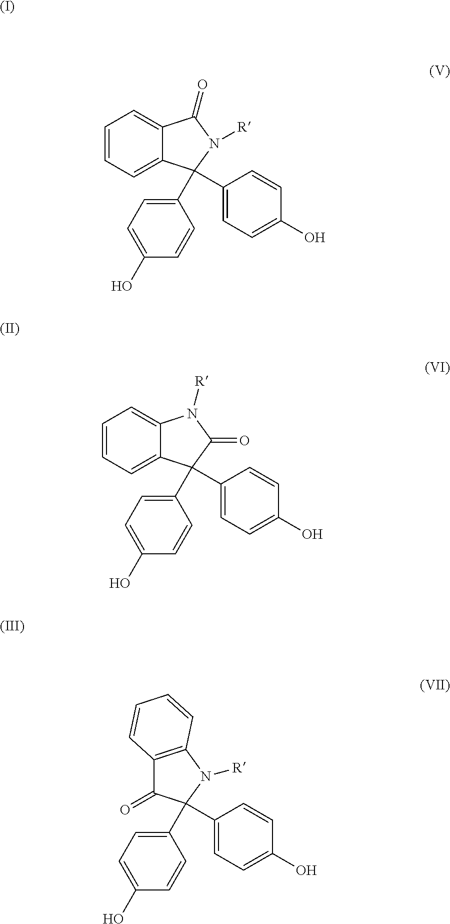
where in formulas (V) to (VII) R′ in each case represents C₁-C₄ alkyl, aralkyl or aryl.

27. The process as claimed in claim 26, wherein the dihydroxy compound in process step (iii) is selected from the group consisting of isomannide, isoidide, and isosorbide and mixtures thereof.

28. A polyester carbonate obtainable by the process as claimed in claim 16.

29. A molding compound comprising a polyester carbonate as claimed in claim 28.

30. A molding comprising a polyester carbonate as claimed in claim 28.
